(19) United States
(12) Patent Application Publication
(10) Pub. No.: US 2025/0139736 A1
(43) Pub. Date: May 1, 2025

(54) RESAMPLING IMAGES WITH DEEP DATA

(71) Applicants: DISNEY ENTERPRISES, INC., Burbank, CA (US); ETH Zürich (Eidgenössische Technische Hochschule Zürich), Zürich (CH)

(72) Inventors: Michael Yves BERNASCONI, Valendas (CH); Xianyao ZHANG, Zürich (CH); Abdelaziz DJELOUAH, Zürich (CH); Christopher Richard SCHROERS, Uster (CH); Gianluca Francesco FIGINI, Vacallo (CH); Richard Warren SAYRE, Oakland, CA (US)

(21) Appl. No.: 18/930,769

(22) Filed: Oct. 29, 2024

Related U.S. Application Data
(60) Provisional application No. 63/594,772, filed on Oct. 31, 2023.

(51) Int. Cl. G06T 3/4007; G06T 7/11; G06T 7/50

(52) U.S. Cl. CPC G06T 3/4007; G06T 7/11; G06T 7/50; G06T 2207/10024; G06T 2207/10028; G06T 2207/20021

(57) ABSTRACT

The present invention sets forth a technique for performing resampling of a deep image. The technique includes receiving a deep image, where the deep image includes one or more channel sample values, each channel sample value including one or more associated depth values and partitioning the deep image into one or more three-dimensional (3D) regions, wherein each 3D region is defined by one or more planar surfaces each including an associated depth value. The technique also includes generating an upsampled image having a greater resolution than the deep image and interpolating, based on a specified interpolation technique, one or more new channel sample values associated with pixels included in the upsampled image. The technique further includes generating an output deep image based on the upsampled image and the one or more new channel sample values.

### CROSS-REFERENCE TO RELATED APPLICATIONS

This application claims priority benefit to the U.S. provisional application titled “RESAMPLING IMAGES WITH DEEP DATA,” filed on Oct. 31, 2023, and having Ser. No. 63/594,772. This related application is also hereby incorporated by reference in its entirety.

### BACKGROUND

### Field of the Various Embodiments

Embodiments of the present disclosure relate generally to computer vision and, more specifically, to techniques for resampling images with deep data.

### Description of the Related Art

In the field of computer vision, a flat image may be a raster image including multiple pixels, where each pixel has an associated (x,y) location within a two-dimensional (2D) rectangular arrangement of X pixels by Y pixels. Each pixel may include one or more associated channels, where each channel associated with a pixel includes a single value. For example, in a red/green/blue (RGB) raster image, each individual pixel may include three channels—an R channel, a G channel, and B channel. Each of the R, G, and B channels includes a single value associated with the individual pixel. An additional channel associated with a pixel may include, for example, an alpha (transparency) value associated with the pixel. A flat image may therefore be expressed as a 2D data space, where each (x,y) location within the rectangular arrangement of pixels includes a single pixel and one or more channels associated with the pixel, where each channel includes a single associated value.

In contrast, each channel in a deep image may include multiple values associated with a single pixel, where each of the multiple values includes an associated depth value z indicating a distance from a real or virtual camera. A deep image may therefore be expressed as a three-dimensional (3D) data space, where each (x,y) location within the rectangular arrangement of pixels potentially includes multiple values per channel associated with the pixel, with each of the multiple values having an associated depth value z in addition to the (x,y) location corresponding to the pixel with which the channel is associated. A deep image may include more depth-related information describing the elements of a scene compared to a flat image. For example, the 3D data space described by a deep image may include depth information related to volumetric elements such as fog or smoke.

Resampling an image includes increasing (upsampling) or decreasing (downsampling) the resolution of the image by inserting new pixels or removing existing pixels, respectively. For example, upsampling an image increases the resolution of the image by inserting new pixels, where channel samples associated with a newly inserted pixel may be calculated based on interpolating corresponding channel samples associated with existing pixels.

Conventional methods of upsampling a deep image may include flattening the deep image into a flat image and then upsampling the flattened image. Flattening techniques combine multiple depth-specific channel sample values associated with a single pixel channel into a single channel sample value. Flattening the deep image simplifies the subsequent interpolation of channel samples associated with newly inserted pixels, as each pixel in the flattened image only includes one sample value per channel, rather than multiple depth-specific channel sample values per channel.

One drawback associated with flattening a deep image prior to upsampling via conventional interpolation techniques is that while the flattened image may appear visually similar or even identical to the deep image, the flattened image no longer contains the depth information associated with multiple sample values included in a single pixel channel. This loss of depth-specific channel information that was previously included in the deep image may complicate later image processing techniques applied to the flattened image, such as applying volumetric elements or other visual effects that are intended to modify specific portions of a depicted scene based on absolute or relative depths associated with the portions included in the depicted scene.

As the foregoing illustrates, what is needed in the art are more effective techniques for resampling images with deep data.

### SUMMARY

One embodiment of the present invention sets forth a technique for resampling deep images. The technique includes receiving a deep image, where the deep image includes one or more channel sample values, each channel sample value including one or more associated depth values, and partitioning the deep image into one or more three-dimensional (3D) regions, wherein each 3D region is defined by one or more planar surfaces each including an associated depth value. The technique also includes generating an upsampled image having a greater resolution than the deep image, interpolating one or more new channel sample values associated with pixels included in the upsampled image, and generating an output deep image based on the upsampled image and the one or more new channel sample values.

One technical advantage of the disclosed techniques relative to the prior art is that the disclosed techniques perform resampling of deep images while preserving depth-specific geometric information in the resulting resampled deep image. Further, the disclosed techniques allow a user to selectively balance the size requirements associated with a resampled deep image against a desired amount of geometric information to be preserved in the resampled deep image. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the partitioning engine of FIG. 1, according to some embodiments.

FIG. 3 is a representation of a portion of a deep image to be resampled, according to some embodiments.

FIG. 4 is a flow diagram of method steps for partitioning a deep image, according to some embodiments.

FIG. 5 is a more detailed illustration of the interpolation engine of FIG. 1, according to some embodiments.

FIG. 6 is a flow diagram of method steps for performing interpolation on a deep image, according to some embodiments.

FIG. 7 is a more detailed illustration of the depth-aware resampling engine of FIG. 1, according to some embodiments.

FIGS. 8A-8E represent different possible arrangements of channel samples included in a deep image, according to some embodiments.

FIG. 9 is a flow diagram of method steps for performing depth-aware resampling on a deep image, according to some embodiments.

FIG. 10 is a representation of the unification of two channel samples into a single channel sample, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

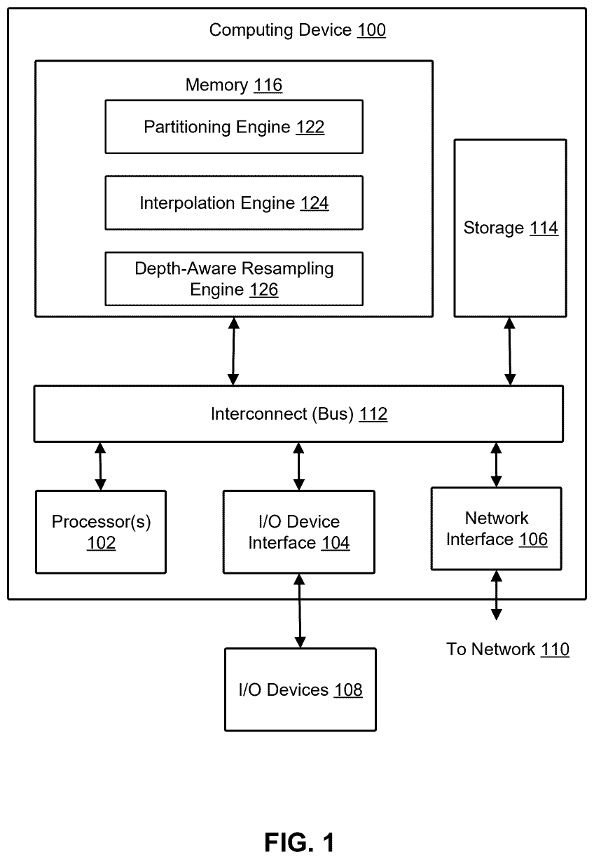

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a partitioning engine 122, an interpolation engine 124, and a depth-aware resampling engine 126 that reside in a memory 116.

It is noted that the computing device described herein is illustrative and that any other technically feasible configurations fall within the scope of the present disclosure. For example, multiple instances of partitioning engine 122, interpolation engine 124, or depth-aware resampling engine 126 could execute on a set of nodes in a distributed and/or cloud computing system to implement the functionality of computing device 100. In another example, partitioning engine 122, interpolation engine 124, or depth-aware resampling engine 126 could execute on various sets of hardware, types of devices, or environments to adapt partitioning engine 122, interpolation engine 124, or depth-aware resampling engine 126 to different use cases or applications. In a third example, partitioning engine 122, interpolation engine 124, or depth-aware resampling engine 126 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Partitioning engine 122, interpolation engine 124, and depth-aware resampling engine 126 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including partitioning engine 122, interpolation engine 124, or depth-aware resampling engine 126.

### Static Scene Partitioning

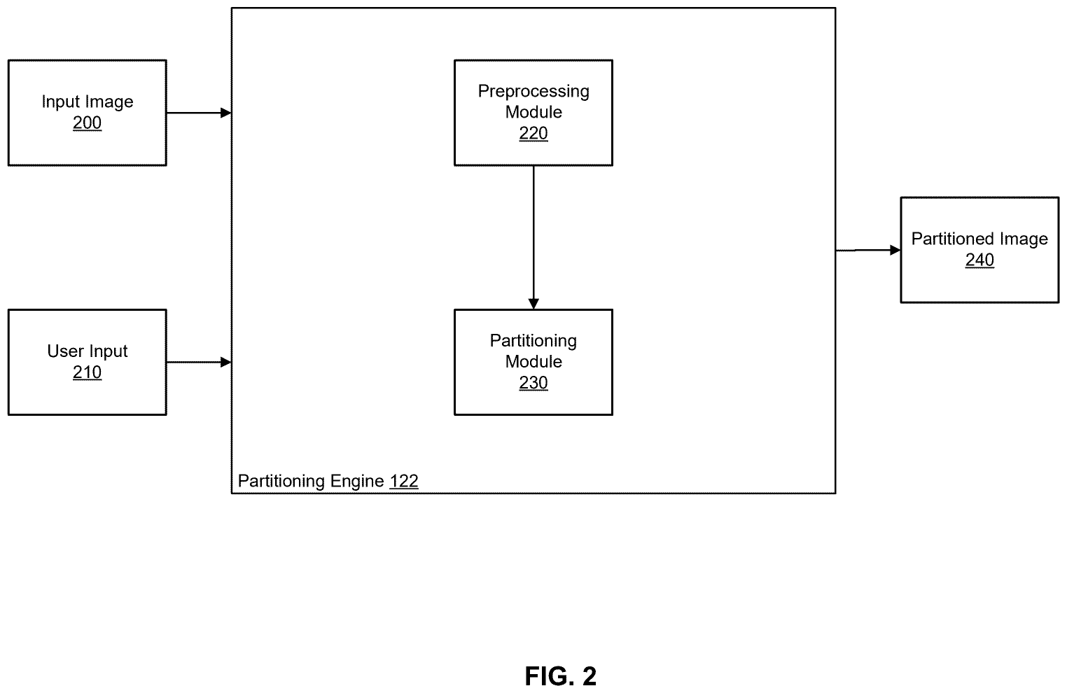

FIG. 2 is a more detailed illustration of partitioning engine 122 of FIG. 1, according to some embodiments. Partitioning engine 122 receives a deep input image 200 and user input 210, and partitions input image 200 into one or more three-dimensional (3D) regions to generate partitioned image 240. Partitioning engine 122 includes, without limitation, preprocessing module 220 and partitioning module 230.

Input image 200 includes a raster image having multiple pixels in a rectangular arrangement. The rectangular arrangement has a width of X pixels and a height of Y pixels, such that each of the multiple pixels is associated with a position within the image having location coordinates (x,y). Each pixel may include one or more channels, where each channel includes at least one channel sample value describing one or more attributes of the pixel. For example, each pixel included in the image may have a red channel R, a green channel G, and a blue channel B. In a pixel having R, G, and B channels, corresponding R, G, and B channel sample values of 255, 255, and 0, respectively, may indicate that the associated pixel exhibits the color yellow. A pixel included in input image 200 may also include an alpha or transparency channel including one or more channel sample values describing the transparency of the associated pixel. The above example channel types are not intended to be limiting; the disclosed techniques are also operable to process an arbitrary number of alternate or additional channel types. An image may include different color channels, such as cyan, magenta, yellow, and black (CMYK). An image may also include channel types describing an albedo (reflectance) value associated with a pixel included in the image, or a texture associated with a pixel included in the image.

Input image 200 may include a deep image, where each channel associated with a pixel may include multiple channel sample values. Each channel sample value included in a channel may include an associated depth value indicating a relative or absolute depth of the channel sample within the image. For example, a channel sample depth value of zero may indicate that the channel sample value is located at the front of the image, closest to the viewer or to a real or virtual camera used to capture input image 200. Larger channel sample depth values may indicate a greater depth for the channel sample value within input image 200. In various embodiments of partitioning engine 122, each channel sample value may include a single associated depth value, indicating that the channel sample value is associated with a specific depth within input image 200, rather than a range of depths.

Preprocessing module 220 of partitioning engine 122 analyzes a received input image 200 and determines one or more characteristics associated with input image 200, such as the width X in pixels, the height in pixels Y, and the number of channels per pixel. Preprocessing module 220 may also ensure that, for each channel, all channel sample depth values included in the channel are sorted in ascending order and non-overlapping. Preprocessing module 220 may also apply one or more transformations to input image 200 based on user input 210, such as global adjustments to contrast, color, or saturation values associated with input image 200.

User input 210 may include user specifications associated with one or more global adjustments as discussed above. User input 210 may also include user criteria specifying how partitioning engine 122 is to divide input image 200 into one or more 3D regions. For example, a user may specify that input image 200 is to be divided into a predetermined number of equally sized 3D regions, or that input image 200 is to be divided into a number of 3D regions, where each 3D region has a specified depth.

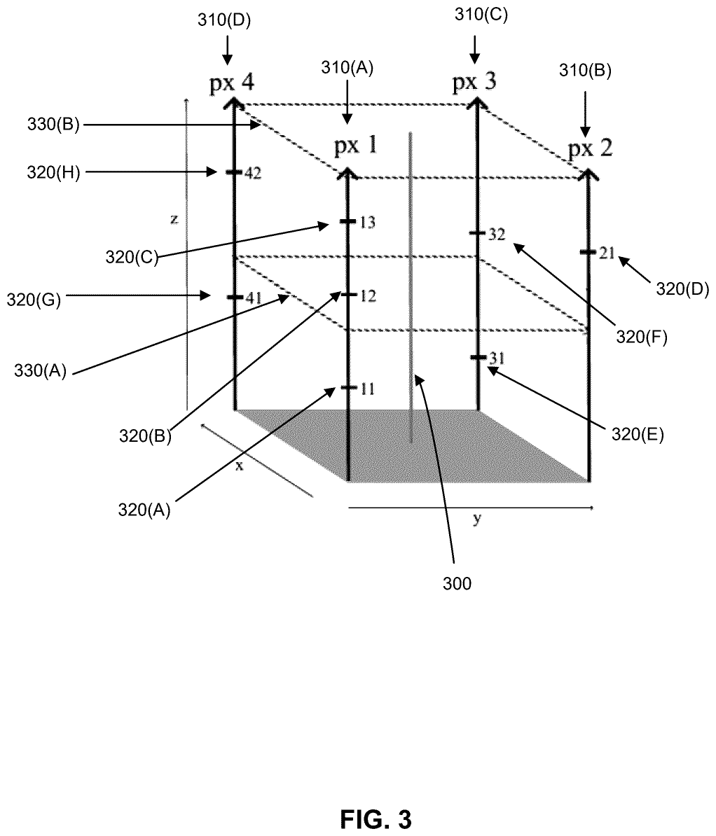

Turning now to FIG. 3, FIG. 3 is a representation of a portion of a deep image to be resampled, according to some embodiments. The portion of the deep image to be resampled includes pixels 310(A-D) that lie within the support of an interpolation technique employed to generate one or more channel sample values associated with a newly inserted pixel 300. Pixels that lie within the support of an interpolation technique are those pixels that the interpolation technique analyzes to generate the sample values associated with the newly inserted pixel 300.

Each of pixels 310(A-D) includes a channel represented by an arrow, where the directionality of the arrow indicates increasing depth within input image 200. Each of pixels 310(A-D) is depicted as including a single associated channel, although each pixel may include multiple channels as described above.

Pixels 310(A-D) include associated channel sample values 320(A-H), where each channel sample value is associated with a particular pixel and includes an associated depth value. For example, channel sample values 320(A), 320(B), and 320(C) are associated with pixel 310(A). The values “11”, “12”, and “13” associated with the respective channel sample values 320(A), 320(B), and 320(C) are merely illustrative, and indicate a number of the associated pixel (in this case, pixel “1”) and a depth order for the channel samples (“1”, “2”, and “3”). For example, channel sample 320(A) has a lower depth value than channel sample 320(B), and channel sample 320(C) has a larger depth value than channel sample 320(B).

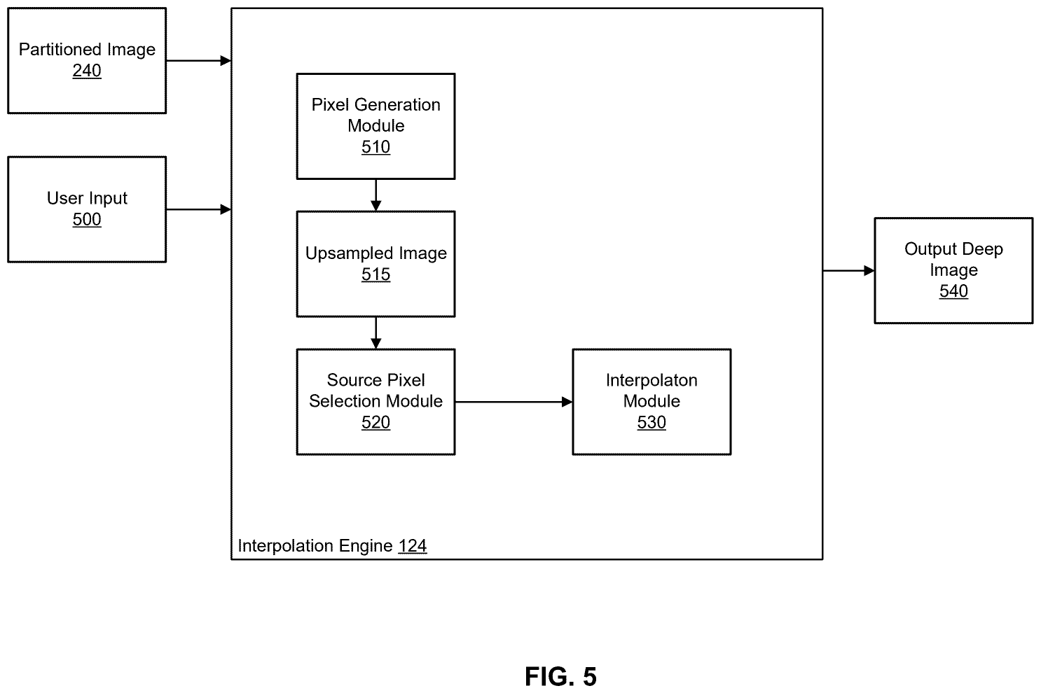

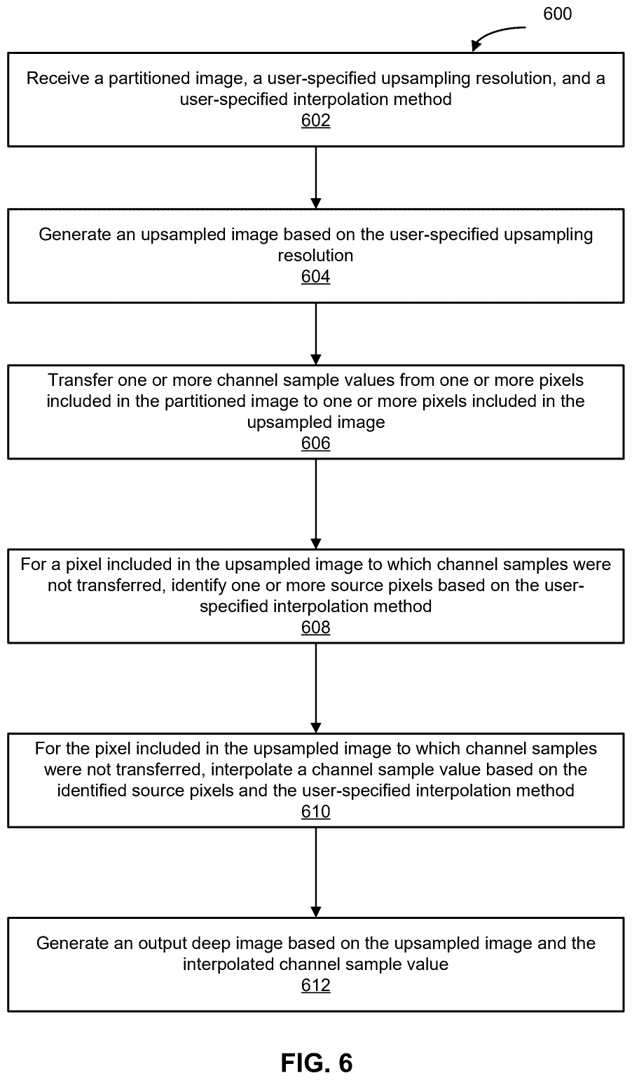

Partitioning engine 122 may divide the portion of the deep image into one or more 3D regions via insertion of planar surfaces 330(A) and 330(B) that are parallel to the camera plane, where each planar surface includes an associated depth value. As shown, planar surfaces 330(A) and 330(B) divide the portion of the deep image into two 3D regions, with the first 3D region extending from the grey plane at the bottom of the figure to planar surface 330(A). The second 3D region extends from planar surface 330(A) to planar surface 330(B). Partitioning engine 122 may divide the portion of the deep image into any number of 3D regions via the insertion of additional planar surfaces. FIG. 3 is discussed further in the description of FIGS. 5 and 6 below.

Returning to FIG. 2, partitioning engine 122 is operable to divide input image 200 into one or more 3D regions based on user criteria included in user input 210. For example, user input 210 may specify one or more particular depth values within input image 200 at which to insert dividing planar surfaces. Alternatively, user input 210 may specify a number of equally sized 3D regions into which to divide input image 200. Partitioning engine 122 may calculate depth values at which to insert dividing planar surface in order to create the specified number of equally sized 3D regions.

In various embodiments, user input 210 may additionally include lower and upper boundary depth values, such that all portions of input image 200 having depth values lower than or equal to the lower boundary depth value form a single 3D region, and all portions of input image 200 having depth values equal to or greater than the upper boundary depth value form a single 3D region. The portion of input image 200 with depth values greater than the lower boundary depth value and lesser than the upper boundary depth value may then be subdivided based on user input 210 as discussed above. In various embodiments, specification of upper and lower boundary depth values may simplify partitioning input image 200, as all portions of input image 200 associated with the foreground of a scene depicted in input image 200 may be consolidated into a single 3D region. Likewise, all portions of input image 200 associated with the background of a scene depicted in input image 200 may be consolidated into a single 3D region.

Partitioning module 230 divides input image 200 into one or more 3D regions based on input image 200 and user input 210, such that each 3D region includes one or more channel sample values associated with pixels included in input image 200. Specifically, partitioning module 230 inserts one or more dividing planar surfaces that form 3D regions withing input image 200. As described above, partitioning module 230 may insert planar surfaces based on user input 210 and generate multiple equally sized 3D regions. Partitioning module 230 may also insert planar surfaces to generate one or more 3D regions between two user-specified depth values. In various embodiments, each of channel sample values 320(A-H) includes a single associated depth value, such that each of channel sample values 320(A-H) resides within exactly one of the one or more 3D regions and does not span multiple 3D regions. Partitioning engine 122 generates partitioned image 240 and transmits partitioned image 240 to interpolation engine 124.

Partitioned image 240 includes input image 200 as divided into one or more 3D regions by the one or more planar surfaces, such as planar surfaces 330(A) and 330(B) inserted by partitioning module 230 described above. Partitioned image 240 preserves all of the individual channel samples 320(A-H) included in input image 200, along with depth values associated with each of the individual channel samples. accordingly, partitioned image 240 is a deep image and preserves all depth characteristics associated with a scene depicted in input image 200, including but not limited to depth-specific color and/or transparency information.

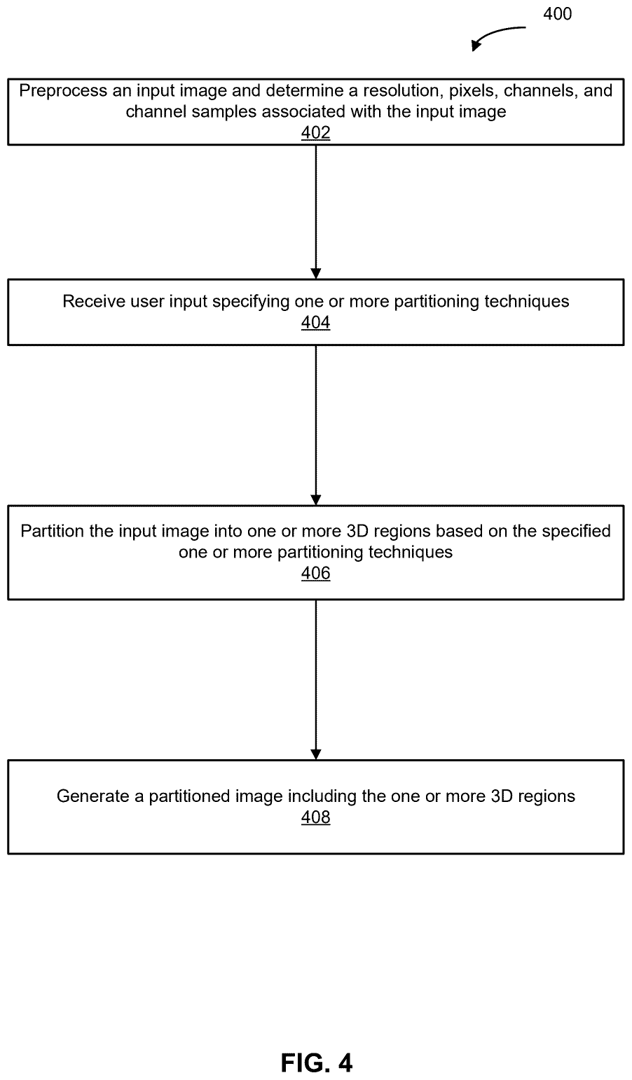

FIG. 4 is a flow diagram of method steps for partitioning a deep image, according to some embodiments. Although the method steps are described in conjunction with the systems of FIGS. 1-2, persons skilled in the art will understand that any system configured to perform the method steps in any order falls within the scope of the present disclosure.

As shown, in step 402 of method 400, partitioning engine 122 receives input image 200, where input image 200 is a deep raster image including multiple pixels in a rectangular arrangement having a width X and a height Y. Each of the multiple pixels includes an associated location (x,y) within the rectangular arrangement. Each of the multiple pixels also includes one or more channels, such as red, blue, green, or transparency channels. Each of the one or more channels further includes one or more channel sample values, where each channel sample value includes an associated depth value. Input image 200 includes depth-specific information associated with a scene depicted in input image 200, such as volumetric fog or smoke effects associated with one or more particular depths.

Preprocessing module 220 analyzes input image 200 and determines one or more characteristics associated with input image 200, such as the width X in pixels, the height in pixels Y, and the number of channels per pixel. Preprocessing module 220 may also ensure that, for each channel, all channel sample depth values included in the channel are sorted in ascending order and non-overlapping. Preprocessing module 220 may also apply one or more transformations to input image 200 based on user input 210, such as global adjustments to contrast, color, or saturation values associated with input image 200.

In step 404, partitioning engine 122 receives user input 210 specifying one or more partitioning techniques. Example user input 210 may include a specified number of equally sized 3D regions into which to divide input image 200. User input 210 may also include one or more depth values specifying boundaries for one or more 3D regions. User input 210 may further include lower and upper boundary depth values, such that all portions of input image 200 having depth values lower than or equal to the lower boundary depth value form a single 3D region representing the foreground of a scene included in input image 200, and all portions of input image 200 having depth values equal to or greater than the upper boundary depth value form a single 3D region representing the background of the scene depicted in input image 200. The portion of input image 200 with depth values greater than the lower boundary depth value and lesser than the upper boundary depth value may then be subdivided based on additional partitioning techniques specified in user input 210.

In step 406, partitioning module 230 of partitioning engine 122 partitions input image 200 into one or more 3D regions based on the partitioning techniques specified in user input 210. Partitioning module generates one or more planar surfaces, such as planar surfaces 330(A) and 330(B), where each planar surface is parallel to the plane of a real or virtual camera used to capture input image 200 and includes an associated depth value indicating a depth position within input image 200. Each of the generated planar surfaces defines a boundary between two adjacent 3D regions of input image 200.

In step 408, partitioning engine 122 generates partitioned image 240. Partitioned image 240 includes a deep image having the same X and Y dimensions as input image 200, and includes the same pixels, channels, and channel sample values as input image 200. Partitioned image 240 preserves all of the visual content included in input image 200, including depth-specific information. Partitioned image 240 differs from input image 200 in that partitioned image 240 is divided into one or more 3D regions, with each 3D region bounded by one or more planar surfaces generated by partitioning module 230. Partitioning engine 122 transmits partitioned image 240 to interpolation engine 124.

FIG. 5 is a more detailed illustration of interpolation engine 124 of FIG. 1, according to some embodiments. In various embodiments, interpolation engine 124 increases the resolution of (i.e., upsamples) partitioned image 240 by generating additional new pixels within partitioned image 240 via an interpolation technique specified in user input 210. Interpolation engine 124 also generates one or more channels associated with each of the new pixels and one or more channel sample values associated with each of the generated channels. Interpolation engine 124 generates an output deep image 540 having an increased resolution while exhibiting the same visual appearance that would have been obtained by first flattening input image 200 into a 2D data space and then upsampling the flattened input image. Interpolation engine 124 includes, without limitation, pixel generation module 510, upsampled image 515, source pixel selection module 520, and interpolation module 530.

Interpolation engine 124 receives partitioned image 240 from partitioning engine 122. As described above, partitioned image 240 includes a deep image having multiple pixels in a rectangular arrangement having a width of X pixels and a height of Y pixels, where each pixel includes one or more channels. Each of the one or more channels includes one or more channel sample values, where each channel sample value includes an associated depth value. Partitioned image 240 is divided into one or more 3D regions, with each 3D region having boundaries defined by one or more planar surfaces generated by partitioning engine 122 as described above.

User input 500 may include a user-specified interpolation technique. In various embodiments, the user-specified interpolation technique may include any technique suitable for upsampling a raster image, including but not limited to Gaussian interpolation, bicubic interpolation, or bilinear interpolation.

User input 500 may also include a desired upsampled resolution for resampled output deep image 540. For example, in an instance where partitioned image 240 includes an associated resolution of X by Y pixels, user input 500 may specify a desired upsampled resolution of X′ by Y′ pixels, where X′ is greater than X and Y′ is greater than Y.

Pixel generation module 510 generates an upsampled image 515 based on the specified interpolation technique and desired upsampled resolution included in user input 500. As an example, for a desired upsampled resolution of X′ by Y′ pixels included in user input 500, pixel generation module 510 generates upsampled image 515 having a width of X′ pixels and a height of Y′ pixels. Each pixel included in upsampled image 515 includes the same number and type of channels included in partitioned image 240, e.g., red, green, blue, or alpha. Pixel generation module 510 also transfers the planar surfaces associated with partitioned image 240 to upsampled image 515, such that upsampled image 515 is partitioned into 3D regions having the same depth-specific boundaries as partitioned image 240.

Based on the desired interpolation technique, pixel generation module 510 transfers each of one or more pixel channel values from partitioned image 240 to calculated pixel locations within upsampled image 515. Pixel generation module 510 further identifies one or more pixels within upsampled image 515 to which pixel channel values were not copied from partitioned image 240. Interpolation engine 124 generates one or more channel values associated with the identified pixels as described below in the discussion of interpolation module 530.

For each of the identified one or more pixels included in upsampled image 515 to which pixel channel values were not copied from partitioned image 240, source pixel selection module 520 identifies one or more source pixels within upsampled image 515 that are within the support of the user-specified interpolation technique. Pixels that are within the support of an interpolation technique include those pixels whose associated channel values are used to interpolate channel sample values associated with the one or more pixels included in upsampled image 515 to which pixel channel values were not copied from partitioned image 240. Source pixel selection module 520 transmits the pixel location of a pixel included in upsampled image 515 to which pixel channel values were not copied from partitioned image 240 to interpolation module 530. Source pixel selection module 520 also transmits the pixel locations of the one or more identified source pixels that are within the support of the user-specified interpolation technique to interpolation module 530.

Interpolation module 530 generates one or more pixel channel values for a pixel included in upsampled image 515 to which pixel channel values were not copied from partitioned image 240, based on the user-specified interpolation technique and pixel channel values associated with the one or more source pixels identified by source pixel selection module 520 discussed above.

Turning again to FIG. 3 as an example, pixel 300 represents a pixel included in upsampled image 515 to which pixel channel values were not copied from partitioned image 240. Interpolation module 530 generates one or more channel sample values associated with pixel 300 based on channel sample values included in source pixels 310(A-D) that have been identified by source pixel selection module 520 as lying within the support of the user-specified interpolation technique. Based on one or more source pixel channel sample values 320 included in a single 3D region within upsampled image 515, interpolation module 530 generates a channel sample value within the single 3D region and associated with pixel 300.

Turning back to FIG. 5, interpolation engine 124 processes upsampled image 515 one 3D region at a time, beginning with the 3D region having the lowest associated depth values, i.e., the 3D region closest to the camera plane. For each pixel included in upsampled image 515 to which pixel channel values were not copied from partitioned image 240, interpolation module 530 generates, via the user-specified interpolation method included in user input 500, a channel sample value based on one or more channel sample values within the 3D region included in one or more identified source pixels. Interpolation module 530 calculates a depth value associated with the generated channel sample value. In some embodiments, interpolation module 530 may assign a depth value equal to a depth value associated with one of the planar surfaces that define the boundaries of the 3D region. Alternatively, interpolation module 530 may assign a depth value equal to the depth-wise midpoint of the 3D region, i.e. a mathematical mean of the two depth values associated with the two planar surfaces that define the 3D region. In other embodiments, interpolation module 530 may assign a depth value based on a weighted average of the depth values associated with the source pixel channel sample values used to interpolate the generated channel sample value, where the weights may be based on the source pixel channel sample values, e.g., transparency values.

Each channel sample value generated by interpolation module 530 is associated with a particular 3D region included in upsampled image 515. However, the visual appearance of a channel sample located within one 3D region depends on channel samples in the same channel that are associated with 3D regions closer to the camera plane, i.e., the 3D regions having lower associated depth values. For example, a channel sample value at the front of upsampled image 515 and having an associated depth value of 0 will block the visibility of channel samples in the same channel that are located at greater depths if the channel sample value having a depth value of zero includes an alpha (transparency) value indicating total opacity. As a result, interpolation module 530 must consider the alpha values of channel samples located in shallower 3D regions when generating channel sample values associated with a deeper 3D region.

Interpolation module 530 determines the channel sample values based on the alpha values of channel samples within all 3D regions that have lower associated depth values than the 3D region for which interpolation engine is currently generating channel sample values. As an example, if interpolation module 530 is generating an alpha channel sample value a; and a color channel sample ci, where i denotes that the channel sample is associated with 3D region i, interpolation module 530 may generate adjusted channel sample values α′ᵢ and c′ᵢ:

$${α}_{i}^{′} = \frac{{\sum }_{A ∈ level ( i )} ( {w}_{P} {α}_{A}^{V} )}{{\prod }_{j = 1}^{i - 1} \overline{{α}_{j}^{′}}} {c}_{i}^{′} = \frac{{\sum }_{A ∈ level ( i )} ( {w}_{P} {c}_{A}^{V} )}{{\prod }_{j = 1}^{i - 1} \overline{{α}_{j}^{′}}} \qquad ( 1 )$$

where A represents a source pixel channel sample that lies within the support of the user-specified interpolation method, level (i) represents the current 3D region, α_{A}^{V} represents the alpha channel value associated with channel sample A, c_{A}^{V} represents the color channel value associated with channel sample A, and w_{P} represents a weighting factor associated with channel sample A. The denominator Πⱼ₌₁ⁱ⁻¹α̅′̅ⱼ̅ represents the product of all adjusted alpha values α′ for channel samples within 3D regions having lower associated depth values than the current 3D region i.

Interpolation module 530 generates channel sample values and associated channel sample depth values for each pixel included in upsampled image 515 to which pixel channel values were not copied from partitioned image 240. This process continues until all pixels included in upsampled image 515 include at least one channel sample value for the 3D region having the lowest range of depth values (either copied from partitioned image 240 or generated by interpolation module 530). Interpolation module 530 then repeats the above interpolation process for the 3D region having the next-lowest associated depth values, until interpolation module 530 has processed all 3D regions included in partitioned image 240. Interpolation engine 124 generates output deep image 540.

Output deep image 540 includes a raster image having the same upsampled resolution (X′ by Y′) as upsampled image 515. Each pixel in output deep image 540 includes one or more channels, where each channel includes one or more channel sample values each including an associated depth value. Output deep image 540 exhibits the same visual appearance as would result from first flattening input image 200 into a 2D data space and then upsampling flattened input image 200 to the desired upsampled resolution (X′ by Y′). In contrast to flattening and then upsampling input image 200, output deep image 540 includes depth values associated with each channel sample value (whether copied from partitioned image 240 or generated by interpolation engine 124) and preserves the depth information associated with the scene depicted in input image 200. Subsequent video effects (VFX) operations may conveniently modify output deep image 540 with volumetric effects that act on depth-specific portions of output deep image 540, such as fog, smoke, or lighting effects. Such depth-specific modifications would be significantly more complicated to apply to a deep image that had first been flattened into a 2D data space and then upsampled.

FIG. 6 is a flow diagram of method steps for performing interpolation on a deep image, according to some embodiments. Although the method steps are described in conjunction with the systems of FIGS. 1-2 and 5, persons skilled in the art will understand that any system configured to perform the method steps in any order falls within the scope of the present disclosure.

As shown, in step 602 of method 600, interpolation engine 124 receives partitioned image 240 and user input 500 including a user-specified upsampling resolution and a user-specified interpolation method. Partitioned image 240 includes a deep raster image, where each pixel included in partitioned image 240 includes one or more channels each having one or more channel sample values and associated depth values. The user-specified upsampling resolution may be expressed as having a width of X′ pixels and a height of Y′ pixels, where the upsampled resolution (X′ multiplied by Y′) is greater than a resolution (X multiplied by Y) associated with partitioned image 240. The user-specified interpolation method may include any interpolation technique suitable for upsampling images, such as nearest neighbor, linear, bilinear, bicubic, or Gaussian interpolation.

In step 604, pixel generation module 510 of interpolation engine 124 generates an upsampled image 515 based on the desired upsampled resolution included in user input 500. As an example, for a desired upsampled resolution of X′ by Y′ pixels included in user input 500, pixel generation module 510 generates upsampled image 515 having a width of X′ pixels and a height of Y′ pixels. Each pixel included in upsampled image 515 includes the same number and type of channels included in partitioned image 240, e.g., red, green, blue, or alpha. Pixel generation module 510 also transfers the planar surfaces associated with partitioned image 240 to upsampled image 515, such that upsampled image 515 is partitioned into 3D regions having the same depth-specific boundaries as partitioned image 240,

In step 606, pixel generation module 510 transfers each of one or more pixel channel values from partitioned image 240 to calculated pixel locations within upsampled image 515 based on the user-specified interpolation technique. Pixel generation module 510 further identifies one or more pixels within upsampled image 515 to which pixel channel values were not copied from partitioned image 240.

In step 608, source pixel selection module 520 identifies, for each of the identified one or more pixels included in upsampled image 515 to which pixel channel values were not copied from partitioned image 240, one or more source pixels within upsampled image 515 that are within the support of the user-specified interpolation technique. Pixels that are within the support of an interpolation technique include those pixels whose associated channel values are used to interpolate channel sample values for the one or more pixels included in upsampled image 515 to which pixel channel values were not copied from partitioned image 240.

In step 610, interpolation module 530 generates one or more pixel channel values for a pixel included in upsampled image 515 to which pixel channel values were not copied from partitioned image 240, based on the user-specified interpolation technique and pixel channel values associated with the one or more source pixels identified by source pixel selection module 520. In various embodiments, interpolation module 530 processes upsampled image 515 one pixel at a time and generates interpolated channel sample values on a per-region basis, beginning with the 3D region having the lowest associated channel sample depth values and proceeding to the 3D region having the next-lowest associated channel sample depth values, until all 3D regions included in upsampled image 515 have been processed.

In step 612, interpolation engine 124 generates output deep image 540. Output deep image 540 includes the same upsampled resolution and 3D region boundaries as upsampled image 515. Each pixel included in output deep image 540 includes one or more channels. Each of the one or more channels includes one or more channel sample values and depth values associated with each channel sample value, where the channel sample values and associated depth values associated with each pixel were either transferred from partitioned image 240 by pixel generation module 510 or generated via interpolation by interpolation module 530.

Method 600 processes upsampled image 515 one pixel at a time within the 3D region of upsampled image 515 having the lowest associated depth values, i.e., the 3D region closest to the camera plane. Method 600 then processes pixels included in the 3D region of upsampled image 515 having the next-lowest associated depth values, until all pixels included in upsampled image 515 include channel sample values within each of one or more 3D regions. Accordingly, method 600 may repeat one or more of steps 608 and 610, proceeding on a per-pixel basis within a 3D region before processing the next 3D region in a similar per-pixel manner.

### Depth-Aware Resampling

The static scene partitioning technique described above in reference to FIGS. 2-6 is suitable for upsampling deep images having channel sample values that each include a single associated depth value, i.e., point samples. The static scene partitioning technique also relies on a user-specified partitioning method, such as a specified number of equally sized 3D partitions, or explicitly defined depth boundaries defining one or more 3D partitions.

Another embodiment of the present invention described below instead performs depth-aware resampling of a deep image, which is suitable for upsampling deep images that may include both volume samples and point samples. In a volume sample, a channel sample includes both a starting depth value and an ending depth value, such that the channel sample is associated with a depth range within the deep image. A volume sample may include a single constant channel value throughout its associated depth range, or may include a mathematical function that determines a potentially different channel value for the channel sample at each of one or more depth values within the depth range.

Depth-aware resampling does not rely on user-specified planar surfaces to define boundaries for one or more 3D regions within the deep image. Rather, depth-aware resampling dynamically partitions the deep image based on the depth values associated with channel samples included in the deep image. The dynamic partitioning allows the depth-aware resampling technique to process volume samples as well as point samples, and also allows a user to choose between prioritizing the conservation of the geometrical information included in the deep image or adjusting the size of an output file by limiting the number of samples stored in the upsampled image.

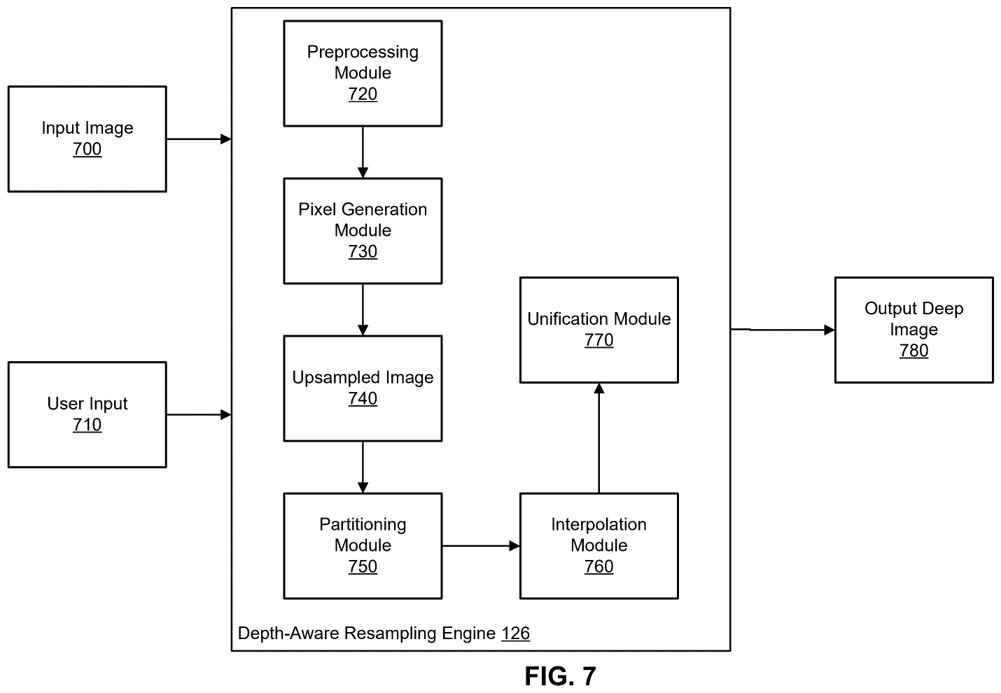

FIG. 7 is a more detailed illustration of depth-aware resampling engine 126 of FIG. 1, according to some embodiments. Depth-aware resampling engine 126 receives input image 700 and user input 710 and generates output deep image 780. Depth-aware resampling engine 126 includes, without limitation, preprocessing module 720, pixel generation module 730, upsampled image 740, partitioning module 750, interpolation module 760, and unification module 770.

Input image 700 includes a raster image having multiple pixels in a rectangular arrangement. The rectangular arrangement has a width of X pixels and a height of Y pixels, such that each of the multiple pixels is associated with a position within the image having location coordinates (x,y). Each pixel may include one or more channels, where each channel includes at least one channel sample value describing one or more attributes of the pixel. For example, each pixel included in the image may have a red channel R, a green channel G, and a blue channel B. In a pixel having R, G, and B channels, corresponding R, G, and B channel sample values of 255, 255, and 0, respectively, may indicate that the associated pixel exhibits the color yellow. A pixel included in input image 700 may also include an alpha or transparency channel including one or more channel sample values describing the transparency of the associated pixel.

Input image 700 may include a deep image, where each channel associated with a pixel may include multiple channel sample values. Each channel sample value included in a channel may include an associated depth value indicating a relative or absolute depth of the channel sample within the image. For example, a channel sample depth value of zero may indicate that the channel sample value is located at the front of the image, closest to the view or to a real or virtual camera used to capture input image 700. Larger channel sample depth values may indicate a greater depth for the channel sample value within input image 700. A point channel sample value may include a single associated depth value z, indicating that the channel sample value is associated with a specific depth within input image 700. Alternatively, a volume channel sample value may include an associated starting depth value z and an ending or back depth value z_{b}, where z<z_{b}.

User input 710 may include one or more user-specified global transformations, such as global adjustments to contrast, color, or saturation values associated with input image 700. User input 710 may include user-specified unification parameters Δαₘₐₓ and Δcₘₐₓ. Unification parameters Δαₘₐₓ and Δcₘₐₓ allow a user to adjust the operation of depth-aware resampling engine 126 to balance the fidelity of output deep image 780 to the original input image 700 and the size of output deep image 780. Unification parameters Δαₘₐₓ and Δcₘₐₓ are discussed in greater detail in the description of unification module 770 below.

User input 710 may also include a desired upsampled resolution for resampled output deep image 780. For example, in an instance where partitioned image 240 includes an associated resolution of X by Y pixels, user input 500 may specify a desired upsampled resolution of X′ by Y′ pixels, where X′ is greater than X and Y′ is greater than Y.

User input 710 may include a user-specified interpolation technique. In various embodiments, the user-specified interpolation technique may include any technique suitable for upsampling a raster image, including but not limited to Gaussian interpolation, bicubic interpolation, or bilinear interpolation.

Preprocessing module 720 of depth-aware resampling engine 126 analyzes a received input image 700 and determines one or more characteristics associated with input image 700, such as the width X in pixels, the height in pixels Y, and the number of channels per pixel. Preprocessing module 720 may also ensure that, for each channel, all channel sample values included in the channel are sorted in increasing depth order and non-overlapping. Preprocessing module 220 may also apply one or more global adjustments to input image 700 as specified in user input 710.

Pixel generation module 730 generates an upsampled image 740 based on the desired upsampled resolution included in user input 710. As an example, for a desired upsampled resolution of X′ by Y′ pixels included in user input 710, pixel generation module 730 generates upsampled image 740 having a width of X′ pixels and a height of Y′ pixels. Each pixel included in upsampled image 740 includes the same number and type of channels included in input image 700, e.g., red, green, blue, or alpha.

Pixel generation module 730 transfers each of one or more pixel channel values from input image 700 to calculated pixel locations within upsampled image 740. Pixel generation module 730 further identifies one or more pixels within upsampled image 740 to which pixel channel values were not copied from input image 700. Depth-aware resampling engine 126 generates one or more channel values associated with the identified pixels as described below in the discussion of interpolation module 760. Pixel generation module 730 transmits upsampled image 740 to partitioning module 750.

Partitioning module 750 receives upsampled image 740 and identifies one or more pixels included in upsampled image 740 to which channel sample values were not copied from input image 700 by pixel generation module 730. For each of the one or more identified pixels, depth-aware resampling engine 126 identifies one or more pixels included in upsampled image 740 to which channel sample values were transferred from input image 700 and that lie within the support of the user-specified interpolation function included in user input 710. The channel sample values that were transferred from input image 700 and that lie within the support of the interpolation function may be referred to as “original samples.” Each original sample includes an associated starting depth z, and an ending depth z_{b}. A sample for which z is less than z_{b} represents a volume sample, while an original sample for which z is equal to z_{b} represents a point sample.

Partitioning module 750 processes the original samples in depth order, starting with the sample closest to the camera plane, i.e., the sample having the lowest depth value z. Partitioning module 750 maintains a non-empty list of original samples that are being processed and that are located in the same depth region. That is, the original samples in the list must all have the same z and Z values. Partitioning module 750 may split an original sample at a calculated depth value to ensure that no original samples other than the ones included in the list of original samples being processed overlap the depth region occupied by the original samples included in the list of original samples being processed. As the original samples are processed in ascending order based on their associated depth values, original samples included in the list to be processed will have the smallest z values among the original samples that have not yet been processed. Partitioning module 750 determines that no original samples other than the ones included in the list of original samples being processed overlap the depth region occupied by the original samples included in the list of original samples being processed, partitioning module 750 transmits the list of original samples being processed to interpolation module 760 described below.

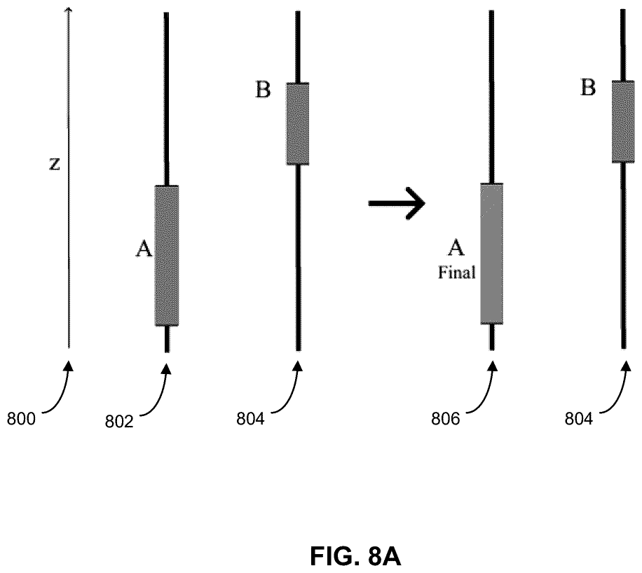

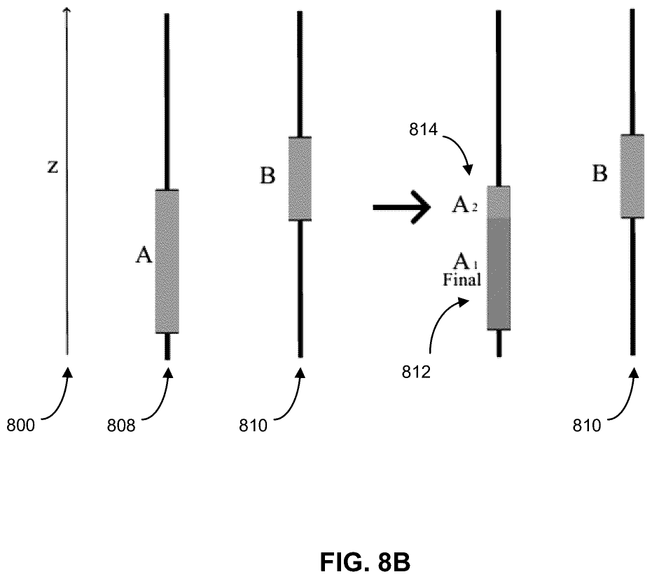

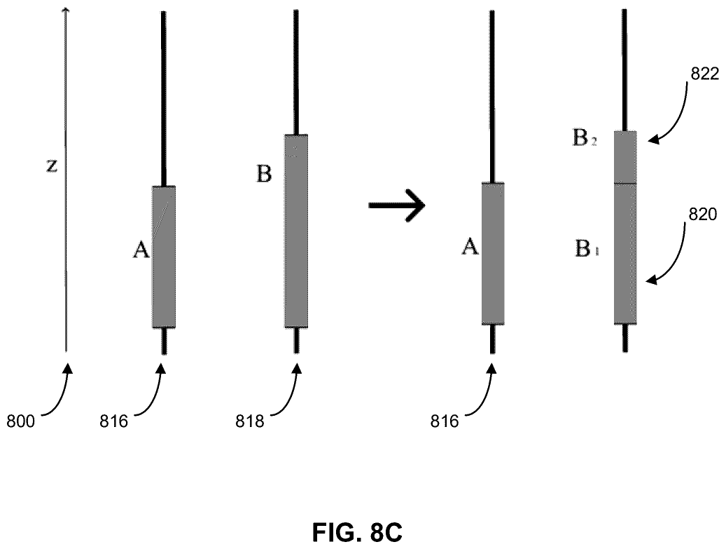

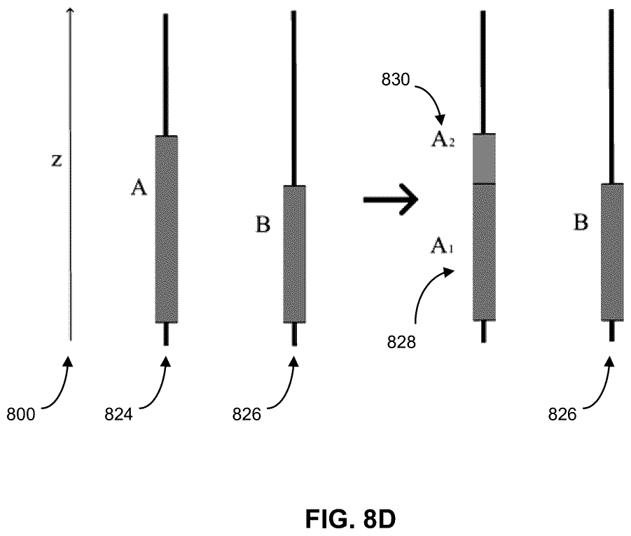

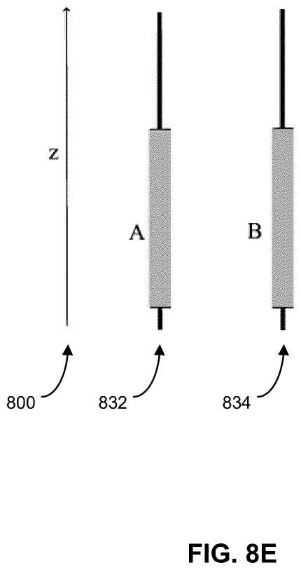

To illustrate how partitioning module 750 may select original samples for processing and/or divide original samples, we turn to FIGS. 8A-8E. FIGS. 8A-8E represent different possible arrangements of original samples included in a deep image. Partitioning module 750 may take one or more of several actions depending on the arrangement of the original samples that lie within the support of the user-specified interpolation method.

In each of FIGS. 8A-8E, sample A represents all of the original samples included in the list of original samples to be processed. Partitioning module 750 iteratively considers the next original sample B in depth order, which is yet to be processed and is not already in the list of original samples being processed. If there exists no next original sample yet to be processed, partitioning module 750 assigns an invalid sample reference X to B.

FIG. 8A depicts a scenario where B=X, or where there is no overlap between A and B. Depth scale 800 indicates relative depths of the original samples A 802 and B 804, where the directionality of depth scale 800 indicates the direction of increasing depth. As shown, there is no overlap between A and B, i.e., z_{A}<z_{B} and zb_{A}≤z_{B}. Consequently, there is no sample outside the list of original samples being processed that overlaps the interval z_{A} to zb_{A}. In this scenario, partitioning module 750 designates A 802 as A_{final} 806 and transmits A_{final} 806 to interpolation module 760 described below. In the next iteration, the list of original samples being processed will only include B 804.

FIG. 8B depicts a scenario where there is an intersection between A 808 and B 810, with z_{A}<z_{B}<zb_{A}. In this scenario, partitioning module 750 splits A 808 by dividing all the samples in the current list of original samples A 808 at depth z_{B}, resulting in two new lists of samples, A₁_{^{final}} 812 and A₂ 814. Samples in A₁_{^{final}} 812 span the depth interval from z_{A} to z_{B}, and samples in A₂ 814 span the interval from z_{B} to zb_{A}. Similar to the scenario depicted in FIG. 8A above, after partitioning module 750 splits A 808, there is no original sample that overlaps the samples in A₁_{^{final}} 812. Partitioning module transmits A₁_{^{final}} 812 to interpolation module 760. In the next iteration, the list of original samples being processed will be A₂ 814, and B 810 will still be the next sample to process.

FIG. 8C depicts a scenario where A 816 overlaps with B 818, such that z_{A}=z_{B} and zb_{A}<zb_{B}. In this scenario, partitioning module 750 splits B 818 at depth zb_{A}. The first portion B₁ 820 resulting from the split will now have the same depth values as A 826, and will be included with A 816 in the list of original samples being processed. The second portion B₂ 822 will be returned to the list of yet-to-be-processed original samples.

FIG. 8D depicts a scenario where A 824 overlaps with B 826, such z_{A}=z_{B}, but in this scenario, zb_{A}>zb_{B}. In this scenario, partitioning module 750 splits A 824 at depth zb_{B}, generating A₁ 828 and A₂ 830. As in the scenario depicted above in FIG. 8C, original sample B 826 now has the same depth values as the first portion of the original samples A₁ 828 resulting from the split. In the next iteration, the list of processed samples will contain A₁ 828 and B 826. A₂ 830 will be returned to the list of yet-to-be-processed original samples.

FIG. 8E depicts a scenario where A 832 overlaps perfectly with B 834. In this scenario, partitioning module 750 adds B 834 to the list A 832 of original samples being processed. Partitioning module 750 then transmits A 832 to interpolation module 760.

Returning to FIG. 7, partitioning module 750 continues to iteratively process any remaining original channel samples associated with pixels that lie within the support of the user-specified interpolation method included in user input 710. At each iteration, partitioning module 750 transmits the lists A of original channel samples marked as final to interpolation module 760.

As noted above, during a single iteration, all original channel samples included in a final list A and transmitted to interpolation module 760 necessarily have the same starting depth value z_{A} and the same ending depth value zb_{A}. As a result, partitioning module 750 dynamically partitions upsampled image 740 into one or more 3D regions, with each 3D region having boundaries defined by the values of z_{A} and zb_{A} associated with the original channel samples included in a particular list A.

Interpolation module 760 generates, based on the user-specified interpolation method, channel sample values for one or more pixels included in upsampled image 740 to which channel sample values were not transferred from input image 700. Each of the generated channel sample values may include, e.g., a color value c and an alpha (transparency) value a. Interpolation module 760 determines the values of c and a for a generated channel sample value based on a weighted combination of the c and a values associated with the original channel samples included in a list A received from partitioning module 750.

Each original channel sample list A is associated with a particular 3D region included in upsampled image 740 having a starting depth value z_{A} and an ending depth value zb_{A}, where z_{A} is less than zb_{A}. Consequently, the color value c and the alpha value a generated by interpolation module 760 based on a received list A are associated with the same 3D region. Depending on the user-specified interpolation method, interpolation module may assign the generated color and alpha values to a single depth within the 3D region, or may generate a function that defines varying color and alpha values for varying depths within the 3D region.

Similar to the operation of interpolation module 530 included in interpolation engine 124 described above, interpolation module 760 must adjust the generated color and alpha values for a particular 3D depth region based on the alpha values of 3D regions that are shallower than the particular 3D region. For a 3D region i, interpolation module 760 keeps track of previously generated channel sample values when generating final sample Fᵢ associated with the 3D region i:

$${F}_{i} = average ( {A}_{1} , … , {A}_{n} ) = ( \frac{{{\sum }_{j = 1}^{n}}_{} {w}_{{A}_{j}} {α}_{{A}_{j}}^{V}}{{\prod }_{k = 1}^{i - 1} \overline{{α}_{{F}_{k}}}} , \frac{{{\sum }_{j = 1}^{n}}_{} {w}_{{A}_{j}} {c}_{{A}_{j}}^{V}}{{\prod }_{k = 1}^{i - 1} \overline{{α}_{{F}_{k}}}} , {z}_{{A}_{i}} , {zb}_{{A}_{i}} ) \qquad ( 2 )$$

where the variables have the same meanings as Equation (1) above, and the terms z_{A}_{ᵢ} and zb_{A}_{ᵢ} represent the lower and upper depth values associated with 3D region i, respectively.

Interpolation module 760 interpolates channel sample color and alpha values for each of one or more pixels included in upsampled image 740 to which channel sample values were not transferred from input image 700. For each of the one or more pixels, interpolation module generates channel sample values within each 3D region defined by the depths associated with the lists A received from partitioning module 750. After interpolation module 760 has processed the last of the lists A received from partitioning module 750, upsampled image 740 includes a rectangular arrangement of X′ by Y′ pixels, with each pixel in the arrangement having one or more channels. Each of the one or more channels includes channel sample values associated with one or more 3D regions included in upsampled image 740. Upsampled image 740 perfectly conserves the geometrical information of the scene depicted in input image 700, while also exhibiting a visual appearance identical to the result that would have been achieved if input image 700 were first flattened into a 2D data space and then upsampled via interpolation based on the user-specified interpolation method.

Unification module 770 may combine depthwise-adjacent channel samples associated with a single channel included in upsampled image 740, based on unification parameters Δαₘₐₓ and Δcₘₐₓ included in user input 710. By combining adjacent channel samples in a single channel, unification module 770 may reduce the number of distinct channel samples included in upsampled image 740, reducing the output file size of output deep image 780. The user-specified values associated with parameters Δαₘₐₓ and Δcₘₐₓ allow the user to define a balance between preserving geometrical information of the scene depicted in input image 700 and an acceptable file size for output deep image 780.

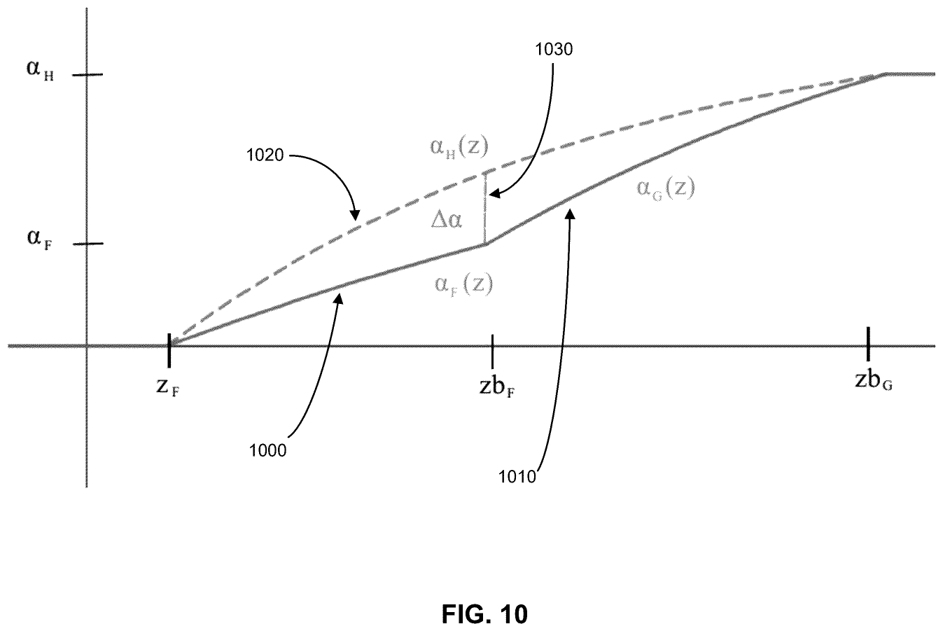

Turning now to FIG. 10, FIG. 10 depicts two depthwise-adjacent channel alpha value functions, α_{F}(z) 1000 and α_{G}(z) 1010. α_{F}(z) 1000 and α_{G}(z) 1010 represent depth-dependent functions that generate color or alpha values based on a particular depth z. Unification module 770 generates a single channel value function α_{H}(z) 1020 that spans the combined depth range of α_{F}(z) 1000 and α_{G}(z) 1010 from z_{F} to zb_{G} and attempts to duplicate depth-specific alpha values generated by α_{F}(z) 1000 and α_{G}(z) 1010:

$$H = ( \frac{1}{2} ( \frac{{c}_{F}}{{α}_{F}} + \frac{{c}_{G}}{{α}_{G}} ) ( {α}_{F} + {α}_{G} \overline{{α}_{F}} ) , {α}_{F} + {α}_{G} \overline{{α}_{F}} , {z}_{F} , {zb}_{G} ) \qquad ( 3 )$$

where c_{F} and c_{G} are color values associated with channel value functions F and G, respectively, α_{F} and α_{G} are alpha values generated by channel value functions F and G, respectively. The final two terms z_{F} and zb_{G} represent the starting and ending depth values associated with channel value function H.

Unification module 770 determines whether the composition of channel value functions F and G is acceptably similar to channel value function H. If so, unification module 770 may replace channel value functions F and G with channel value function H, thereby reducing the number of channel samples included in the channel. Unification module 770 determines an acceptable level of similarity based on user-specified unification parameters Δαₘₐₓ and Δcₘₐₓ included in user input 710. Unification module 770 determines Aa 1030 by comparing the alpha values generated by α_{F}(z) 1000, α_{G}(z) 1010, and α_{H}(z) 1020 at depth zb_{F}:

$$Δα = \vert 1 - {( {α}_{F} + {α}_{G} \overline{{α}_{F}} )}^{\frac{{z}_{G} - {zb}_{G}}{{z}_{F} - {zb}_{G}}} ) - {α}_{F} \vert < {Δα}_{max} \qquad ( 4 )$$

Unification module 770 also compares color values generated by channel value functions F and G to the user-specified parameter Δcₘₐₓ to ensure that channel value functions F and G generate similar colors:

$$Δ c = ‖ \frac{{c}_{F}}{{α}_{F}} - \frac{{c}_{G}}{{α}_{G}} ‖ < Δ {c}_{max} \qquad ( 5 )$$

If Δα<Δαₘₐₓ and Δc<Δcₘₐₓ, then unification module 770 replaces channel value functions F and G with channel value function H. This replacement reduces the total number of channel sample values in the channel, reducing the size of output deep image 780. However, channel value function H only approximates the composition of channel value functions F and G. Therefore, replacing channel value function F and G with channel value function H may reduce the fidelity of upsampled image 740 to input image 700.

If Δα≥Δαₘₐₓ or Δc≥Δcₘₐₓ, then unification module 770 discards channel value function Hand keeps the original channel value function F and G. Based on the values of user-specified parameters Δαₘₐₓ and Δcₘₐₓ, a user may balance the fidelity of upsampled image 740 to input image 700 against a desired file size for output deep image 780.

Returning to FIG. 7, depth-aware resampling engine 126 generates output deep image 780 based on the output of unification module 770. Output deep image 780 includes a raster image having the same upsampled resolution (X′ by Y′) as upsampled image 740. Each pixel in output deep image 780 includes one or more channels, where each channel includes one or more channel sample values each including an associated depth value. Output deep image 780 exhibits approximately the same visual appearance as would result from first flattening input image 700 into a 2D data space and then upsampling flattened input image 700 to the desired upsampled resolution (X′ by Y′). In contrast to flattening and then upsampling input image 700, output deep image 780 includes depth values associated with each channel sample value (whether copied from input image 700 or generated by interpolation module 760) and preserves the depth information associated with the scene depicted in input image 700. Subsequent video effects (VFX) operations may conveniently modify output deep image 780 with volumetric effects that act on depth-specific portions of output deep image 780, such as fog, smoke, or lighting effects. Such depth-specific modifications would be significantly more complicated to apply to a deep image that had first been flattened into a 2D data space and then upsampled.

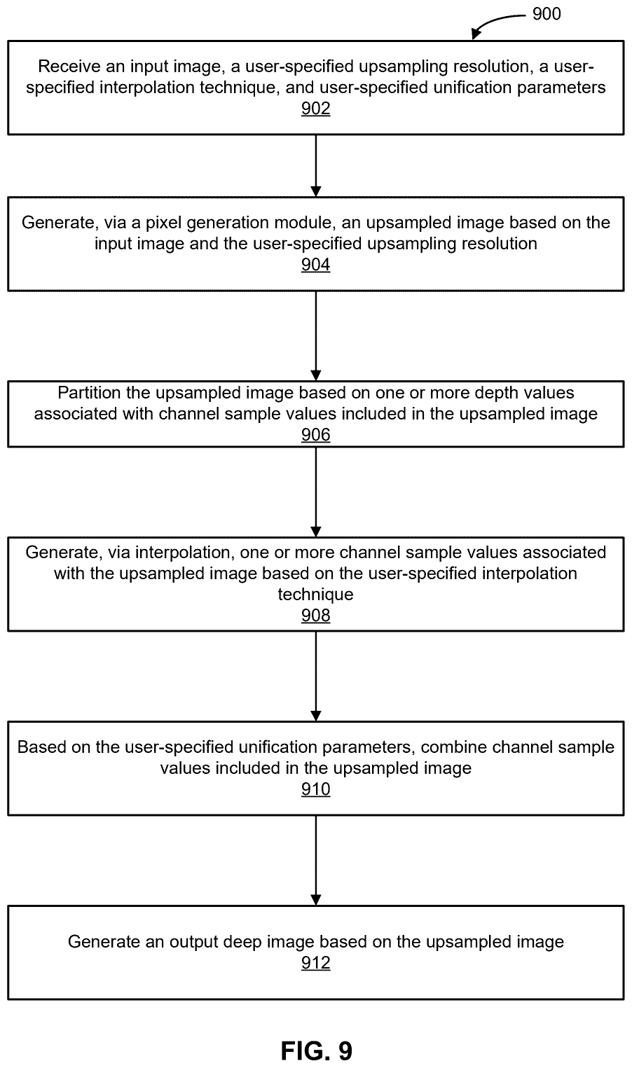

FIG. 9 is a flow diagram of method steps for performing depth-aware resampling on a deep image, according to some embodiments. Although the method steps are described in conjunction with the systems of FIGS. 1 and 7, persons skilled in the art will understand that any system configured to perform the method steps in any order falls within the scope of the present disclosure.

As shown, in step 902 of method 900, depth-aware resampling engine 126 receives input image 700, as well as a user-specified upsampling resolution, a user-specified interpolation technique, and user-specified unification parameters included in user input 710. Input image 700 is a deep image having a width of X pixels and a height of Y pixels, having multiple channel sample values associated with each channel included in input image 700. Each channel included in input image 700 includes one or more channel sample values, where each channel sample value includes an associated depth range. The user-specified upsampling resolution includes a desired width of X′ pixels and a height of Y′ pixels, where X′ multiplied by Y′ is greater than X multiplied by Y. The user-specified interpolation technique may include any interpolation technique suitable for performing upsampling, such as nearest neighbor, linear, bilinear, bicubic, or Gaussian interpolation.

In step 904, pixel generation module 730 generates upsampled image 740 based on input image 700 and the user-specified interpolation technique. Pixel generation module 730 generates upsampled image 740 having the desired upsampling resolution X′ by Y′ and having the same number and type of channels per pixel as input image 700, e.g., red, green, blue, and alpha (transparency) channels. Pixel generation module 730 transfers one or more channel sample values from input image to upsampled image 740, based on the user-specified interpolation technique. Pixel generation module 730 also identifies pixels included in upsampled image 740 for which depth-aware resampling engine 126 will generate channel sample values.

In step 906, partitioning module 750 partitions the upsampled image based on one or more depth values associated with channel sample values included in the upsampled image. For a given pixel within upsampled image 740 for which depth-aware resampling engine 126 is to generate new channel sample values, partitioning module 750 identifies one or more pixels included in upsampled image 740 to which channel sample values were transferred from input image 700 and that lie within the support of the user-specified interpolation function included in user input 710. The channel sample values that were transferred from input image 700 and that lie within the support of the interpolation function may be referred to as “original samples.” Each original sample includes an associated starting depth z, and an ending depth z_{b}. A sample for which z is less than z_{b} represents a volume sample, while an original sample for which z is equal to z_{b} represents a point sample.

Partitioning module 750 processes the original samples in depth order, starting with the sample closest to the camera plane, i.e., the sample having the lowest depth value z. Partitioning module 750 maintains a non-empty list of original samples that are being processed and that are located in the same depth region. That is, the original samples in the list must all have the same z and z_{b} values. Partitioning module 750 may split an original sample at a calculated depth value to ensure that no original samples other than the ones included in the list of original samples being processed overlap the depth region occupied by the original samples included in the list of original samples being processed. As the original samples are processed in ascending order based on their associated depth values, original samples included in the list to be processed will have the smallest z values among the original samples that have not yet been processed. Partitioning module 750 determines that no original samples other than the ones included in the list of original samples being processed overlap the depth region occupied by the original samples included in the list of original samples being processed, partitioning module 750 transmits the list of original samples being processed to interpolation module 760. Partitioning module 750 splits an original channel sample value by partitioning upsampled image 740 at a depth corresponding to the depth at which partitioning module 750 splits the original channel sample value.

In step 908, interpolation module 760 generates one or more channel sample values associated with the upsampled image to which channel sample values were not transferred from input image 700. Each of the generated channel sample values may include a color value c and an alpha (transparency) value a. Interpolation module 760 determines the values of c and a for a generated channel sample value based on a weighted combination of the c and a values associated with the original channel samples included in a list A received from partitioning module 750.

Each original channel sample list A is associated with a particular 3D region included in upsampled image 740 having a starting depth value z_{A} and an ending depth value zb_{A}, where z_{A} is less than zb_{A}. Consequently, the color value c and the alpha value a generated by interpolation module 760 based on a received list A are associated with the same 3D region. Depending on the user-specified interpolation method, interpolation module may assign the generated color and alpha values to a single depth within the 3D region, or may generate a function that defines varying color and alpha values for varying depths within the 3D region.

In step 910, unification module 770 may combine depthwise-adjacent interpolated channel sample values based on the user-specified unification parameters included in user input 710. For depthwise-adjacent interpolated channel value functions F and G, unification module 770 generates a combined channel value function H that approximates the color and alpha values determined by channel value functions F and G. Based on the user-specified unification parameters Δαₘₐₓ and Δcₘₐₓ included in user input 710, unification module 770 determines whether the color and alpha values generated by channel value function Hare acceptably close to the color and alpha values generated by channel value functions F and G. If the values are acceptably close, unification module 770 replaces channel value functions F and G with channel function value H over the depth range associated with channel value functions F and G, reducing the total number of channel samples included in upsampled image 740. By adjusting unification parameters Δαₘₐₓ and Δcₘₐₓ, a user may balance the fidelity of upsampled image 740 to input image 700 with the file size of upsampled image 740.

In step 912, depth-aware resampling engine 126 generates output deep image 780. Output deep image 780 includes a raster image having the same upsampled resolution (X′ by Y′) as upsampled image 740. Each pixel in output deep image 780 includes one or more channels, where each channel includes one or more channel sample values each including an associated depth value. Output deep image 780 exhibits approximately the same visual appearance as would result from first flattening input image 700 into a 2D data space and then upsampling flattened input image 700 to the desired upsampled resolution (X′ by Y′). In contrast to flattening and then upsampling input image 700, output deep image 780 includes depth values associated with each channel sample value (whether copied from input image 700 or generated by interpolation module 760) and preserves the depth information associated with the scene depicted in input image 700. Subsequent video effects (VFX) operations may conveniently modify output deep image 780 with volumetric effects that act on depth-specific portions of output deep image 780, such as fog, smoke, or lighting effects. Such depth-specific modifications would be significantly more complicated to apply to a deep image that had first been flattened into a 2D data space and then upsampled.

In sum, the disclosed techniques perform deep image resampling by dividing a deep image into multiple three-dimensional (3D) regions bounded by two-dimensional (2D) planes that are parallel to a real or virtual camera used to capture or generate the deep image. The number of parallel plane boundaries and the depth associated with each of the plane boundaries may be determined statically prior to dividing the deep image, or may be determined dynamically in an iterative depth-aware fashion based on depth value ranges associated with one or more channel sample values included in the deep image. The disclosed techniques individually perform upsampling on each of the multiple regions via interpolation to generate additional pixels and channel sample values associated with the additional pixels. Each of the newly generated channel samples may include an associated depth value, such that the disclosed techniques generate a modified deep output image.

In operation, a partitioning engine receives an input deep image. A deep image may include a raster image having multiple pixels arranged in a rectangular array having a width X and a height Y. Each of the multiple pixels includes one or more channels, such as red, green, and blue channels included in an RGB image. Each of the multiple pixels may also include an alpha (transparency) channel. A channel associated with a pixel may include multiple values, where each value included in the channel has an associated depth value representing an absolute or relative distance from a real or virtual camera used to capture or generate the deep image. The multiple channel samples and associated depth values differentiate the deep image from a flat image, where each channel associated with a pixel includes only one value. Because a channel included in a deep image may have multiple values and associated depths, a deep image may capture more geometric information included in a depicted scene compared to a flat image.

The partitioning engine divides the deep image into two or more regions, where boundaries associated with the two or more regions are defined by planar surfaces that are parallel to the real or virtual camera used to capture or generate the deep image. Each of the parallel planar surfaces has an associated depth value, such that each of the two or more regions represents a 3D volume within the deep image. A region may be associated with one or more pixels, where each pixel includes one or more channels. Each of the one or more channels may include multiple channel samples each having an associated depth value, such that each channel sample falls within exactly one of the regions defined within the deep image. The partitioning engine may select the planar surfaces defining the region boundaries via static scene partitioning based on predetermined criteria, such as a predetermined number of regions or a predetermined depth per region. A user may also define one or more areas of interest within the deep image. For example, a user may direct that all channel samples with an associated depth value greater than a specified value, e.g., channel samples associated with a background depicted in the deep image, be grouped together into a single region. Generating a larger region that includes a greater number of samples associated with a channel reduces the size of the output deep image after interpolation, as subsequently applied interpolation techniques will only generate a single channel sample per region for each channel associated with a newly added pixel.

An interpolation engine upsamples the partitioned input deep image by generating new pixels, channels, and associated channel sample values via interpolation of original channel samples, increasing the resolution of the deep image. The interpolation engine processes the partitioned deep image one 3D region at a time. For each new pixel, the interpolation engine generates new channel sample values associated with the new pixel, including but not limited to color, opacity, or depth. The interpolation engine may employ any suitable interpolation technique, such as nearest neighbor, linear, bilinear, bicubic, or Gaussian interpolation. The interpolation engine generates an output deep image having a higher resolution than the input deep image.

The static partitioning and interpolation techniques above are best suited to original channel samples each having a single associated depth value, i.e. point samples. For an input deep image that includes one or more channel samples each having a range of associated depth values, i.e. volume samples, the disclosed techniques may include a depth-aware resampling technique that iteratively processes an input deep image based on the depth values associated with channel samples included in the input deep image, including both point and volume samples.

A depth-aware resampling engine receives an input deep image that may include one or more volume channel samples or point channel samples. Based on a specified interpolation technique, the depth-aware resampling engine selects one or more original pixels included in the input deep image that fall within the support of the selected interpolation technique, i.e., the specified interpolation technique will generate a new pixel and channel values associated with the new pixel based on the selected original pixels in the deep input image.

The depth-aware resampling engine retrieves original channel samples associated with one or more selected original pixels, where each channel sample includes an associated depth value or range of depth values. The original channel samples are processed in depth order, starting from the channel sample with the lowest starting depth value, i.e., the sample closest to the camera. Based on the comparative depth values for the channel sample with the lowest starting depth value and the channel sample with the next-lowest starting depth value, the depth-aware processing engine may dynamically generate one or more planar surfaces defining volume regions within the input deep image. The placement depths of the one or more planar partitions are based on whether the two channel samples overlap completely, overlap partially, or are disjoint with no overlaps. After the depth-aware resampling engine defines a volume region via placement of a planar partitioning surface, the depth-aware resampling engine performs a user-specified interpolation function and generates a new channel sample value and associated depth values within the region. The depth-aware resampling engine continues the iterative partitioning and interpolation operations until the entire input deep image has been resampled. The depth-aware resampling engine then generates a resampled deep output image having a higher resolution than the deep input image.

The depth-aware resampling engine may generate a large number of volume regions, and may therefore generate a large number of channel samples associated with a new interpolated pixel. To reduce the number of channel samples and the file size of the resampled deep output image, the depth-aware resampling engine may unify two different channel sample values that are depth-wise adjacent into a single channel sample that approximates the values of the two adjacent channel samples within one or more predetermined thresholds over the depth range associated with the two adjacent channel samples. Adjusting the one or more predetermined thresholds allows a user to balance the fidelity of the output deep image to the input deep image and the size of the output deep image.

One technical advantage of the disclosed techniques relative to the prior art is that the disclosed techniques perform resampling of deep images while preserving depth-specific geometric information in the resulting resampled deep image. Further, the disclosed techniques allow a user to selectively balance the size requirements associated with a resampled deep image against a desired amount of geometric information to be preserved in the resampled deep image. These technical advantages provide one or more improvements over prior art approaches.

1. In some embodiments, a computer-implemented method for resampling deep images, the computer-implemented method comprises receiving a deep image, where the deep image includes one or more channel sample values, each channel sample value including one or more associated depth values, partitioning the deep image into one or more three-dimensional (3D) regions, wherein each 3D region is defined by one or more planar surfaces each including an associated depth value, generating an upsampled image having a greater resolution than the deep image, interpolating, based on a specified interpolation technique, one or more new channel sample values associated with pixels included in the upsampled image, and generating an output deep image based on the upsampled image and the one or more new channel sample values.

2. The computer-implemented method of clause 1, wherein the depth values associated with the one or more planar surfaces are provided by a user.

3. The computer-implemented method of clauses 1 or 2, wherein the depth values associated with the one or more planar surfaces are determined dynamically based on one or more depth values associated with channel sample values included in the upsampled image.

4. The computer-implemented method of any of clauses 1-3, wherein the depth values associated with the one or more planar surfaces are automatically calculated to generate a predetermined number of 3D regions within the deep image.

5. The computer-implemented method of any of clauses 1-4, wherein each of the one or more channel sample values includes a color value or a transparency value.

6. The computer-implemented method of any of clauses 1-5, further comprising replacing two interpolated channel sample value functions with a single channel sample value function having an associated range of depth values corresponding to the ranges of depth values associated with the two interpolated channel sample values.

7. The computer-implemented method of any of clauses 1-6, wherein the single channel sample value function generates depth-dependent color or transparency channel sample values that are similar to the depth-dependent color or transparency channel sample values generated by the two interpolated channel sample value functions to within one or more predefined thresholds.

8. The computer-implemented method of any of clauses 1-7, wherein each of the one or more planar surfaces is parallel to a plane associated with a real or virtual camera used to capture the deep image.

9. The computer-implemented method of any of clauses 1-8, wherein one of the one or more planar surfaces divides a channel sample into two depth-adjacent channel samples at a calculated depth value.

10. The computer-implemented method of any of clauses 1-9, wherein at least one of the one or more channel sample values includes an associated starting depth value and an associated ending depth value, the ending depth value being greater than the starting depth value.

11. In some embodiments, one or more non-transitory computer-readable media store instructions that, when executed by one or more processors, cause the one or more processors to perform the steps of receiving a deep image, where the deep image includes one or more channel sample values, each channel sample value including one or more associated depth values, partitioning the deep image into one or more three-dimensional (3D) regions, wherein each 3D region is defined by one or more planar surfaces each including an associated depth value, generating an upsampled image having a greater resolution than the deep image, interpolating, based on a specified interpolation technique, one or more new channel sample values associated with pixels included in the upsampled image, and generating an output deep image based on the upsampled image and the one or more new channel sample values.

12. The one or more non-transitory computer-readable media of clause 11, wherein the depth values associated with the one or more planar surfaces are provided by a user.

13. The one or more non-transitory computer-readable media of clauses 11 or 12, wherein the depth values associated with the one or more planar surfaces are determined dynamically based on one or more depth values associated with channel sample values included in the upsampled image.

14. The one or more non-transitory computer-readable media of any of clauses 11-13, wherein the depth values associated with the one or more planar surfaces are automatically calculated to generate a predetermined number of 3D regions within the deep image.

15. The one or more non-transitory computer-readable media of any of clauses 11-14, further comprising replacing two interpolated channel sample value functions with a single channel sample value function having an associated range of depth values corresponding to the ranges of depth values associated with the two interpolated channel sample values.

16. The one or more non-transitory computer-readable media of any of clauses 11-15, wherein the single channel sample value function generates depth-dependent color or transparency channel sample values that are similar to the depth-dependent color or transparency channel sample values generated by the two interpolated channel sample value functions to within one or more predefined thresholds.

17. The one or more non-transitory computer-readable media of any of clauses 11-16, wherein each of the one or more planar surfaces is parallel to a plane associated with a real or virtual camera used to capture the deep image.

18. The one or more non-transitory computer-readable media of any of clauses 11-17, wherein one of the one or more planar surfaces divides a channel sample into two depth-adjacent channel samples at a calculated depth value.

19. In some embodiments, a system comprises one or more memories storing instructions, and one or more processors for executing the instructions to receive a deep image, where the deep image includes one or more channel sample values, each channel sample value including one or more associated depth values, partition the deep image into one or more three-dimensional (3D) regions, wherein each 3D region is defined by one or more planar surfaces each including an associated depth value, generate an upsampled image having a greater resolution than the deep image, interpolate, based on a specified interpolation technique, one or more new channel sample values associated with pixels included in the upsampled image, and generate an output deep image based on the upsampled image and the one or more new channel sample values.

20. The system of clause 19, wherein the depth values associated with the one or more planar surfaces are determined dynamically based on one or more depth values associated with channel sample values included in the upsampled image.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for resampling deep images, the computer-implemented method comprising:
receiving a deep image, where the deep image includes one or more channel sample values, each channel sample value including one or more associated depth values;
partitioning the deep image into one or more three-dimensional (3D) regions, wherein each 3D region is defined by one or more planar surfaces each including an associated depth value;
generating an upsampled image having a greater resolution than the deep image;
interpolating, based on a specified interpolation technique, one or more new channel sample values associated with pixels included in the upsampled image; and
generating an output deep image based on the upsampled image and the one or more new channel sample values.

2. The computer-implemented method of claim 1, wherein the depth values associated with the one or more planar surfaces are provided by a user.

3. The computer-implemented method of claim 1, wherein the depth values associated with the one or more planar surfaces are determined dynamically based on one or more depth values associated with channel sample values included in the upsampled image.

4. The computer-implemented method of claim 1, wherein the depth values associated with the one or more planar surfaces are automatically calculated to generate a predetermined number of 3D regions within the deep image.

5. The computer-implemented method of claim 1, wherein each of the one or more channel sample values includes a color value or a transparency value.

6. The computer-implemented method of claim 1, further comprising replacing two interpolated channel sample value functions with a single channel sample value function having an associated range of depth values corresponding to the ranges of depth values associated with the two interpolated channel sample values.

7. The computer-implemented method of claim 6, wherein the single channel sample value function generates depth-dependent color or transparency channel sample values that are similar to the depth-dependent color or transparency channel sample values generated by the two interpolated channel sample value functions to within one or more predefined thresholds.

8. The computer-implemented method of claim 1, wherein each of the one or more planar surfaces is parallel to a plane associated with a real or virtual camera used to capture the deep image.

9. The computer-implemented method of claim 1, wherein one of the one or more planar surfaces divides a channel sample into two depth-adjacent channel samples at a calculated depth value.

10. The computer-implemented method of claim 1, wherein at least one of the one or more channel sample values includes an associated starting depth value and an associated ending depth value, the ending depth value being greater than the starting depth value.

11. One or more non-transitory computer-readable media storing instructions that, when executed by one or more processors, cause the one or more processors to perform the steps of:
receiving a deep image, where the deep image includes one or more channel sample values, each channel sample value including one or more associated depth values;
partitioning the deep image into one or more three-dimensional (3D) regions, wherein each 3D region is defined by one or more planar surfaces each including an associated depth value;
generating an upsampled image having a greater resolution than the deep image;
interpolating, based on a specified interpolation technique, one or more new channel sample values associated with pixels included in the upsampled image; and
generating an output deep image based on the upsampled image and the one or more new channel sample values.

12. The one or more non-transitory computer-readable media of claim 11, wherein the depth values associated with the one or more planar surfaces are provided by a user.

13. The one or more non-transitory computer-readable media of claim 11, wherein the depth values associated with the one or more planar surfaces are determined dynamically based on one or more depth values associated with channel sample values included in the upsampled image.

14. The one or more non-transitory computer-readable media of claim 11, wherein the depth values associated with the one or more planar surfaces are automatically calculated to generate a predetermined number of 3D regions within the deep image.

15. The one or more non-transitory computer-readable media of claim 11, further comprising replacing two interpolated channel sample value functions with a single channel sample value function having an associated range of depth values corresponding to the ranges of depth values associated with the two interpolated channel sample values.

16. The one or more non-transitory computer-readable media of claim 15, wherein the single channel sample value function generates depth-dependent color or transparency channel sample values that are similar to the depth-dependent color or transparency channel sample values generated by the two interpolated channel sample value functions to within one or more predefined thresholds.

17. The one or more non-transitory computer-readable media of claim 11, wherein each of the one or more planar surfaces is parallel to a plane associated with a real or virtual camera used to capture the deep image.

18. The one or more non-transitory computer-readable media of claim 11, wherein one of the one or more planar surfaces divides a channel sample into two depth-adjacent channel samples at a calculated depth value.

19. A system comprising:
one or more memories storing instructions; and
one or more processors for executing the instructions to:
receive a deep image, where the deep image includes one or more channel sample values, each channel sample value including one or more associated depth values;
partition the deep image into one or more three-dimensional (3D) regions, wherein each 3D region is defined by one or more planar surfaces each including an associated depth value;
generate an upsampled image having a greater resolution than the deep image;
interpolate, based on a specified interpolation technique, one or more new channel sample values associated with pixels included in the upsampled image; and
generate an output deep image based on the upsampled image and the one or more new channel sample values.

20. The system of claim 19, wherein the depth values associated with the one or more planar surfaces are determined dynamically based on one or more depth values associated with channel sample values included in the upsampled image.
